(19) United States
(12) Patent Application Publication
(10) Pub. No.: US 2010/0258585 A1
(43) Pub. Date: Oct. 14, 2010

(54) WARMING DEVICE FOR HEATING A CARTRIDGE CONTAINING A VISCOUS FLUID

(76) Inventor: Tommy L. Jamison, Hernando, MS (US)

Correspondence Address: HARNESS, DICKEY & PIERCE, P.L.C., P.O. BOX 828, BLOOMFIELD HILLS, MI, 48303, US

(21) Appl. No.: 12/422,480

(22) Filed: Apr. 13, 2009

(51) Int. Cl. B67D 5/00; B67D 5/62; B67D 5/42

(52) U.S. Cl. 222/1; 222/146.2; 222/327

(57) ABSTRACT

A warming device that employs a sheet and a pocket that is coupled to the sheet and configured to hold an exothermic heat pack. The sheet is formed of an insulating material that reflects radiant heat. The pocket is formed of a thermally conductive air permeable material. The warming device is configured to transmit heat into a cartridge containing a viscous liquid to heat the viscous liquid to a desired temperature and/or maintain the viscous liquid at the desired temperature even while working in an environment with a relatively low ambient temperature.

The present invention generally relates to a warming device for heating a cartridge containing a viscous fluid.

The use of viscous materials, such as structural adhesives, sealants and caulk, is widespread in the construction industry. These materials are formulated so as to have a target viscosity at a given temperature to permit the viscous material to be dispensed from a container as well as to permit the material to cure or set in a desired manner. One of the drawbacks to the use of such viscous materials concerns their use in relatively cold weather (e.g., an ambient air temperature of 45° F. or lower). The viscosity of these materials can increase greatly at such temperatures (relative to the material's target viscosity) and consequently, these materials can be difficult to dispense.

The effect on the viscosity of a viscous material can be mitigated to some extent through the use of an insulated and heated storage container. The heated storage container is employed to store cartridges of the viscous material at a work site; the cartridges are removed from the storage container just prior to the time at which the viscous material is to be dispensed.

It will be appreciated, however, that when the ambient temperature of the working environment is sufficiently cold, heat rejected by cartridges that have been removed from the storage container can loose heat rapidly. In one experiment that I conducted, a 37 ml cartridge of a structural adhesive (thermal conductivity of 0.6 W/(m°K)) at a temperature of 74.5° F. was placed in a freezer with an ambient temperature of 30° F. and the temperature of the structural adhesive was monitored as a function of time for twenty minutes. I noted that the temperature of the structural adhesive dropped approximately 1° F. for each minute of the test and that the viscosity of the structural adhesive had nearly doubled by the end of the test.

Since it is not always possible to immediately dispense a viscous material in a construction site upon removal of a cartridge from a storage container, the viscous material may cool to the point where it is difficult to dispense. One example concerns the use of structural adhesives to couple fittings and tubes to form a system (e.g., for the distribution of potable water) as is disclosed in U.S. patent application Ser. No. 12/357,176 entitled “Coupling, Joint and Method for Fixedly and Sealingly Securing Components to One Another”, the disclosure of which is incorporated by reference as if fully set forth in detail herein. When assembling such systems, it can be necessary or desirable to reposition and/or partly disassemble portions of the system prior to the dispensing of a structural adhesive. It can also be necessary or desirable to reposition portions of the system after the dispensing of a structural adhesive. While the delays between individual dispensing events can be relatively short, the cumulative effect of such delays may be sufficient to permit the structural adhesive to be cooled to a point at which its (increased) viscosity renders it difficult to dispense.

### SUMMARY

This section provides a general summary of some aspects of the present disclosure and is not a comprehensive listing or detailing of either the full scope of the disclosure or all of the features described therein.

In one form, the present teachings provide an article with an outer shell and a pocket. The outer shell includes a sheet that is at least partly formed of a material that reflects radiated heat. The outer shell has a first opening on a first side and is configured to receive therein a cartridge that holds a viscous liquid. The pocket is coupled to an interior side of the outer shell and is configured to hold an exothermic heat pack. The pocket is woven from a thermally conductive material having a mesh that is configured to permit air to flow though the woven thermally conductive material to sustain an exothermic reaction in the exothermic heat pack.

In another form, the present teachings provide method for dispensing a viscous liquid. The method includes: providing a cartridge containing the viscous liquid; inserting an exothermic heat pack in a pocket formed of a thermally conductive material; abutting the pocket against the cartridge; and wrapping a radiant heat reflecting material about the pocket and the cartridge.

In yet another form, the present teachings provide a combination that includes a warming device, an exothermic heat pack and a cartridge containing a liquid. The warming device includes a sheet, a closure means and a pocket. The sheet is formed of an insulating material that reflects radiated heat. The closure means is coupled to the sheet and includes first and second portions that releasably engage one another to shape the sheet into a structure with a generally tubular shape. The pocket is coupled to the sheet on a side that positions the pocket within the generally tubular shape when the first and second portions of the closure means releasably engage one another. The pocket is formed of an air permeable thermally conductive material. The exothermic heat pack is received in the pocket. The cartridge is received in the generally tubular shape defined by the sheet and is abutted against the pocket.

Further areas of applicability will become apparent from the description provided herein. It should be understood that the description and specific examples in this summary are intended for purposes of illustration only and are not intended to limit the scope of the present disclosure, its application and/or uses in any way.

### BRIEF DESCRIPTION OF THE DRAWINGS

The drawings described herein are for illustrative purposes only and are not intended to limit the scope of the present disclosure in any way. The drawings are illustrative of selected teachings of the present disclosure and do not illustrate all possible implementations. Similar or identical elements are given consistent identifying numerals throughout the various figures.

FIG. 1 is a side elevation view of a warming device constructed in accordance with the teachings of the present disclosure, the warming device being shown in operative association with an exemplary cartridge and an exemplary dispensing tool;

FIG. 2 is a view similar to that of FIG. 1 but illustrating the warming device exploded from the exemplary cartridge;

FIG. 3 is a plan view of the warming device of FIG. 1 in a flat or unrolled condition;

FIG. 4 is a sectional view of a portion of the warming device of FIG. 1, illustrating the sheet of insulating material in more detail;

FIG. 5 is a plan view of a portion of the warming device of Figure 1, illustrating the sheet of insulating material in more detail;

FIG. 6 is a section view taken along the line 6-6 of FIG. 1;

FIG. 7 is a section view taken along the line 7-7 of FIG. 1;

FIG. 8 is a plan view of a portion of the warming device of Figure 1, illustrating portions of an exemplary closure means that are employed to secure the first closure tab to a cartridge covering portion; and

FIG. 9 is a section view taken along the line 9-9 of FIG. 3.

### DETAILED DESCRIPTION OF THE VARIOUS EMBODIMENTS

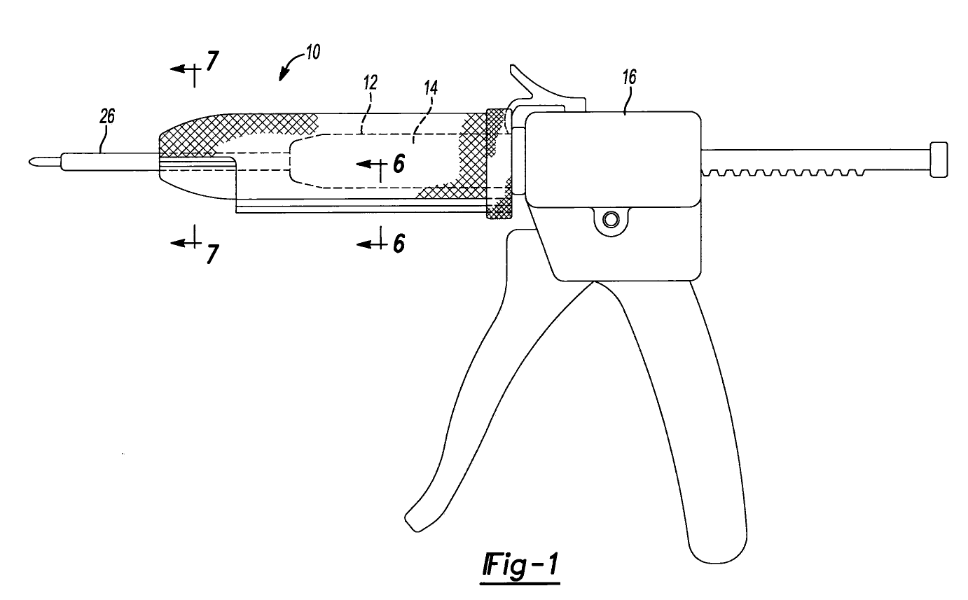

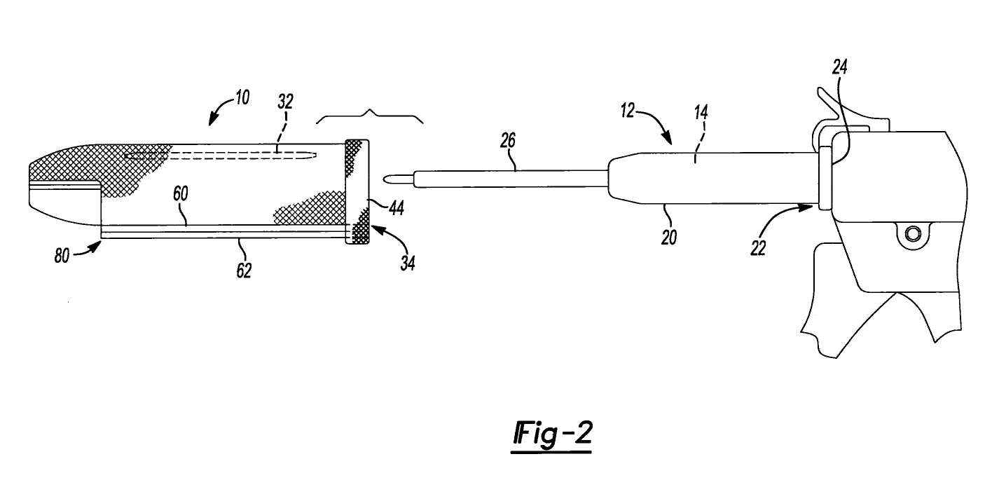

With reference to FIGS. 1 and 2 of the drawings, a warming device constructed in accordance with the teachings of the present invention is generally indicated by reference numeral 10 and is shown in operative association with a cartridge 12, which is filled with one or more viscous fluids (hereinafter referred to simply as “the viscous fluid 14”), and an optional dispensing tool 16 that can be operated to dispense the viscous fluid 14 from the cartridge 12. In the particular example provided, the cartridge 12 is a 50 ml cartridge of DP460 Scotch-Weld™ Epoxy Adhesive marketed by the Minnesota Mining and Manufacturing Company of St. Paul, Minn. and the dispensing tool is a Scotch-Weld™ Plus II Applicator marketed by the Minnesota Mining and Manufacturing Company of St. Paul, Minn. It will be appreciated, however, that the scope of the present disclosure is not limited by the particular viscous fluid, cartridge configuration or dispensing tool that is described herein and depicted in the drawings. It will be appreciated that in certain situations, the dispensing tool 16 may be incorporated into the cartridge 12 (e.g., where the viscous fluid 14 has a relatively low viscosity that may be poured or squeezed from the cartridge 12).

The construction and operation of the cartridge 12 and the dispensing tool 16 are beyond the scope of the present disclosure and as such, these elements will not be discussed in significant detail herein. Briefly, the cartridge 12 can include a wall member 20 that can define a dispensing end 22 and an opposite end 24. A nozzle 26 can be coupled to the dispensing end 22 and can be integrally formed with or removably coupled to the wall member 20. The dispensing tool 16 can be configured to receive or be coupled to the cartridge 12 and can include a mechanism that applies a force to the cartridge 12 to urge the viscous fluid 14 through the nozzle 26.

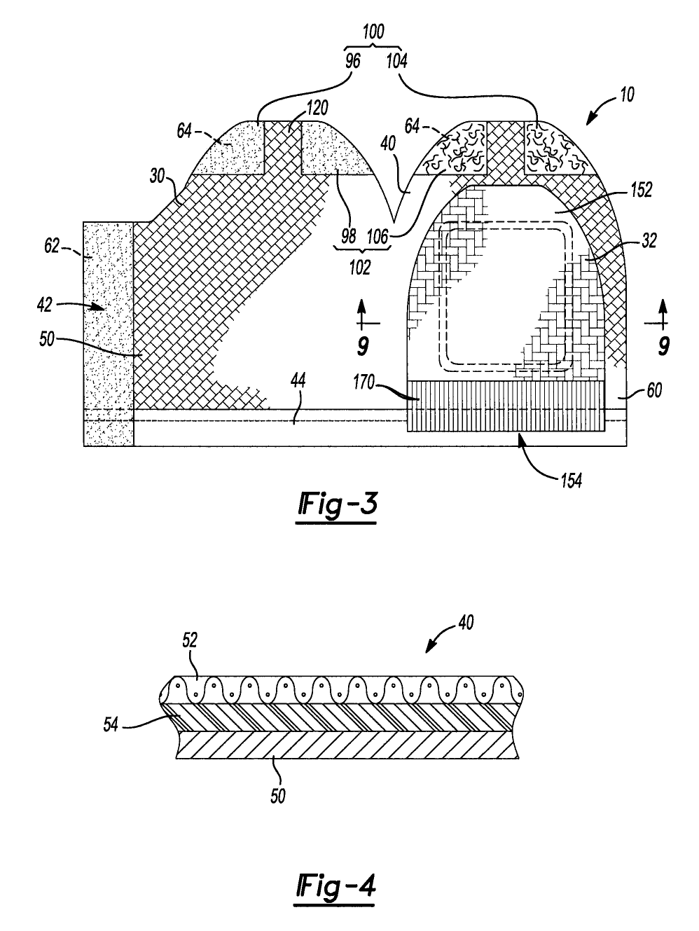

With reference to FIG. 3, the warming device 10 can include an outer shell 30 and one or more pockets 32. The outer shell 30 can include a first opening 34 on a first side through which the cartridge 12 can extend. The outer shell 30 can comprise a sheet 40, a closure means 42 and a welting 44.

The sheet 40 can be formed of an insulating material that is configured to reflect at least 50% of the radiated heat directed to a selected surface of the outer shell 30. Preferably, the insulating material is configured to reflect at least 75% of the radiated heat directed to the selected surface of the outer shell 30 and more preferably, at least 85% of the radiated heat directed to the selected surface of the outer shell 30. With reference to FIG. 4, the sheet 40 can comprise a plurality of layers including a layer formed of a metallic reflecting agent 50. The metallic reflecting agent 50 can have a gold or silver color. In the particular example provided, the sheet includes an outer reinforcing fabric 52 and a plastic film 54 disposed between the metallic reflecting agent 50, which is formed of aluminum, and the outer reinforcing fabric 52. Such material is commonly known as a “space blanket” and is commercially available from various sources, including Grabber of Grand Rapids, Mich. (item number MPIAWB).

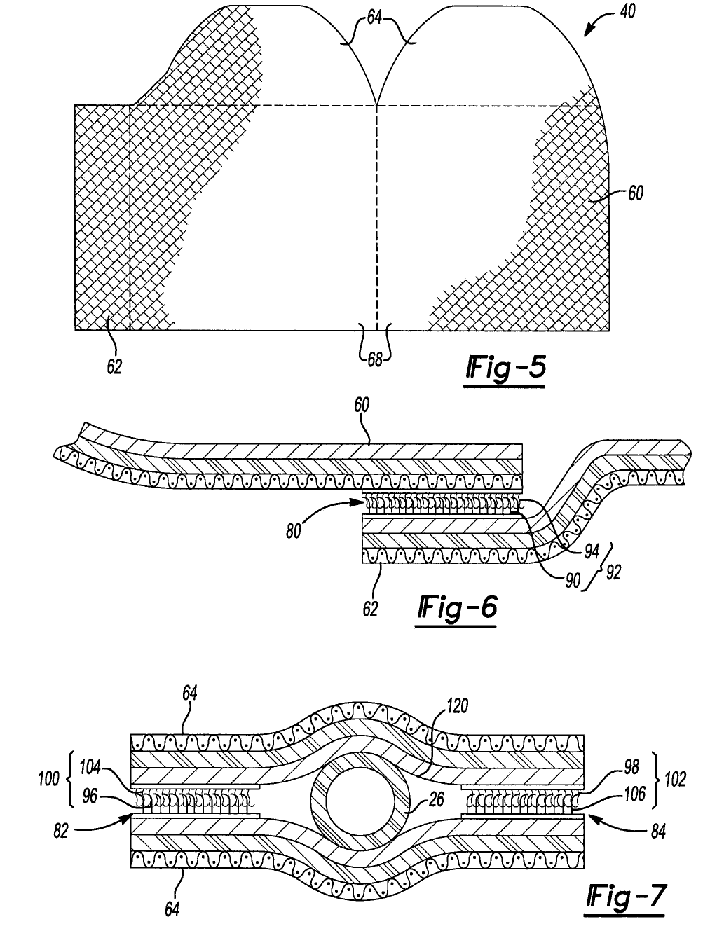

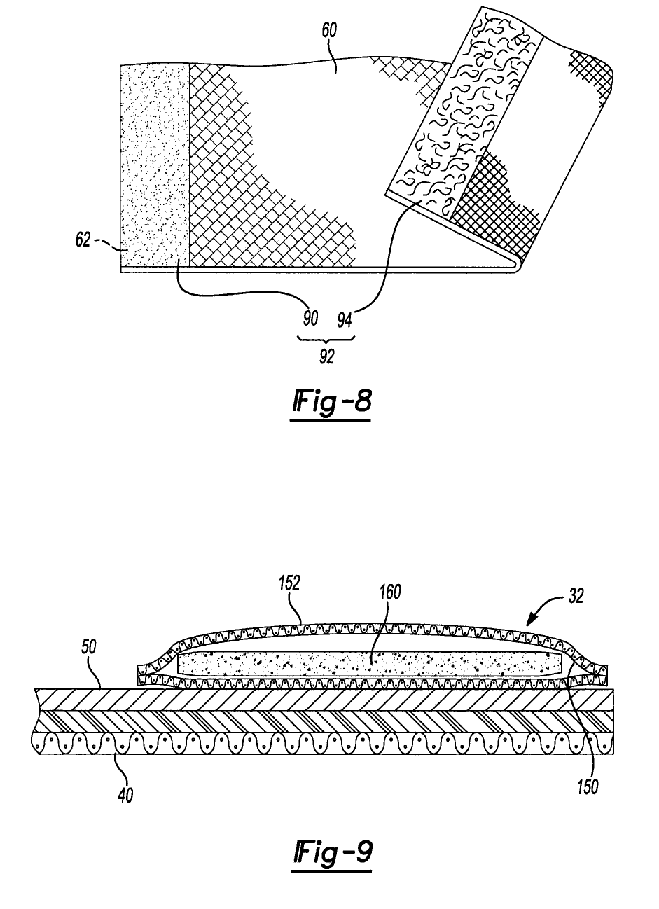

With reference to FIGS. 2 and 5, the sheet 40 can be cut so as to define a cartridge covering portion 60, a first closure tab 62 and a pair of second closure tabs 64. The cartridge covering portion 60 can be sized and shaped to wrap about the circumference of the cartridge 12 to cover the cartridge 12 over all or substantially all of its length. In the example provided, the cartridge covering portion 60 includes two generally rectangular portions 68 that are configured to wrap about the wall member 20 of the cartridge 12. The first closure tab 62 can be coupled to the cartridge covering portion 60 at a desired location, such as a lateral side of the cartridge covering portion 60, and can serve as a mounting point for at least a portion of the closure means 42. The first closure tab 62 can overlie a portion of the cartridge covering portion 60, such as one of the rectangular portions 68, when the cartridge covering portion 60 is wrapped about the cartridge 12. The second closure tabs 64 can be semi-circular in shape and can be coupled to respective ones of the generally rectangular portions 68. The second closure tabs 64 can be configured to cover the dispensing end 22 of the cartridge 12 and optionally a portion of the nozzle 26.

Returning to FIG. 3, the closure means 42 can comprise any means for closing the sheet 40 upon itself to form a pouch-like structure with a generally tubular shape into which the cartridge 12 (FIG. 2) can be received. For example, the closure means 42 can include threads, adhesive and/or fasteners, such as rivets or grommets, that could permanently attach the sides of the sheet to one another. Alternatively, the closure means 42 can be configured to permit a user to at least partly open or unroll the sheet 40 so that it will be easier to install or remove the outer shell 30 to a cartridge 12 (FIG. 2). In this regard, it will be appreciated that various different fasteners could be employed, including without limitation hook-and-loop fasteners, buttons, and/or snaps.

With reference to FIGS. 6 and 7, hook-and-loop fasteners, such as VELCRO® fasteners, are employed in the particular example provided at three attachment interfaces on the sheet 40: a first attachment interface 80, which is shown in FIG. 6, where the first closure tab 62 overlies the cartridge covering portion 60, and second and third attachment interfaces 82 and 84 respectively, which are shown in FIG. 7 where the second closure tabs 64 overlie one another. Accordingly, it will be appreciated that one part 90 of a first hook-and-loop fastener 92 (e.g., the “hook” side) can be coupled to the first closure tab 62 and a second part 94 of the first hook-and-loop fastener 92 can be coupled to a lateral side of the cartridge covering portion 60 opposite the first closure tab 62 as is shown in FIG. 6. It will be appreciated that the elements of the first hook-and-loop fastener 92 are disposed on opposite surfaces of the sheet 40 so that they will engage one another when the first closure tab 62 overlies the cartridge covering portion 60.

With reference to FIGS. 3 and 7, the first parts 96 and 98 of second and third hook-and-loop fasteners 100 and 102, respectively, can be coupled to a first one of the second closure tabs 64 and second parts 104 and 106 of the second and third hook-and-loop fasteners 100 and 102 can be coupled to a second one of the second closure tabs 64. The elements of the second and third hook-and-loop fasteners 100 and 102 can be disposed on the same surface of the sheet 40 so that they will engage one another when the second closure tabs 64 overlie one another.

The elements (i.e., parts 96, 100, 98 and 102) of the second and third hook-and-loop fasteners 100 and 102 can be positioned on respective ones of the second closure tabs 64 so as to create a nozzle space 120 between the second and third hook-and-loop fasteners 100 and 102 when the second closure tabs 64 overlie one another. The nozzle space 120 can be aligned to the nozzle 26 (FIG. 2) to permit the sheet 40 to directly contact the nozzle 26 (FIG. 2) over a desired portion of its length.

The welting 44 can be coupled to a side of the sheet 40 opposite the second closure tabs 64 and/or to a side of the sheet opposite the first closure tab 62 for improved durability.

With reference to FIGS. 3 and 9, the pocket 32 can be a pouch-like structure having opposite (first and second) side surfaces 150 and 152 and an open end 154. The pocket 32 can be fixedly coupled to the sheet 40 through an appropriate fastening means, such as threads, adhesives and/or fasteners, such that a first one of the side surfaces 150 is disposed adjacent the metallic reflecting agent 50. Alternatively, the pocket 32 can be removably coupled to the sheet 40 through fasteners (e.g., snaps) or hook-and-loop fasteners. The pocket 32 can be sized to receive a commercially-available exothermic (chemical) heat pack 160, such as a Model 825B512 disposable hand warmer that is marketed by The Coleman Company, Inc. of Wichita, Kans.; a “Foot Warm Up”, a “HotHands-2” or a “SuperHotHands” disposable warmer that is marketed by Heat Max, Inc. of Dalton, Ga., or a “Toe Warmer” disposable warmer that is marketed by Heat Factory of Vista, Calif. The pocket 32 can be at least partly formed of a thermally conductive material and can be constructed so as to be air permeable. The thermally conductive material can be any suitable material, including a metal (e.g., copper, brass), a thermally conductive carbon or a thermally conductive plastic, and can have a perforated sheets form or a cloth-like form that is formed of threads, wires or fibers. In the particular example provided, the pocket 32 is formed of a thermally conductive carbon cloth having a weave or mesh that is configured to permit air to flow through the thermally conductive carbon cloth to sustain an exothermic reaction in the exothermic heat pack 160. Exemplary thermally conductive carbon cloths include: a pitch-based P-30 thermally conductive carbon fiber having a thermal conductivity of 50 W/(m°K) and a P-55 thermally conductive carbon fiber having a thermal conductivity of 120 W/(m°K), both of which being manufactured by Cytec Industries Inc. of Greenvile, S.C.; and a PAN-based carbon fiber material manufactured by Fabric Development of Quakertown, Pa. having a thermal conductivity of 9.34 W/(m°K). If desired, a second closure means 170, such as an elastic band, snaps and/or hook-and-loop fasteners, can be employed to at least partly close the open end 154 of the pocket 32 to secure the exothermic heat pack 160 therein.

The exothermic heat pack 160 can be activated, typically through exposure to air and/or agitation of the material within the exothermic heat pack 160. The activated exothermic heat pack 160 can be received into the open end 154 of the pocket 32. If desired, the outer shell 30 can be laid flat or opened to the degree permitted by the closure means 42 to provide better access to the pocket 32. The cartridge covering portion 60 of the sheet 40 can be wrapped about the wall member 20 (FIG. 2) of the cartridge 12 (FIG. 2) such that the pocket 32, with the exothermic heat pack 160 received therein, is disposed between the metallic reflecting agent 50 and the wall member 20 (FIG. 2). The first side surface 150 of the pocket 32 can directly abut the sheet 40, while the opposite side surface 152 can directly abut the wall member 20 (FIG. 2). It some situations it may be preferable that the second side surface 152 completely contact the wall member 20 (FIG. 2), but it will be appreciated that various factors, including the contouring of the wall member 20 (FIG. 2), may render only partial contact between the second side surface 152 and the wall member 20 (FIG. 2) possible or practical.

If the closure means 42 permits the outer shell 30 to be at least partially opened, the closure means 42 can be employed to secure the sheet 40 about the cartridge 12 (FIG. 2). In the example provided, the first closure tab 62 can be positioned so as to overlie a portion of the cartridge covering portion 60, the second closure tabs 64 can be aligned to one another, the parts—and—of the first hook-and-loop fastener 92 can be engaged to one another to secure the cartridge covering portion 60 about the cartridge 12, the parts 96, 100 and 98, 102 of the second and third hook-and-loop fasteners 100 and 102 can be engaged to one another to close an end of the outer shell 30. As noted previously, if the cartridge 12 (FIG. 2) include a nozzle 26 (FIG. 2), placement of the second and third hook-and-loop fasteners 100 and 102 apart from one another to create a nozzle space 120 permits the nozzle 26 (FIG. 2) to extend through the warming device 10.

The cartridge 12 (FIG. 2) may be removed from the warming device 10 at a desired time, such as after dispensing the viscous fluid 14 (FIG. 2) from the cartridge 12 (FIG. 2). In situations where the closure means 42 permits the outer shell 30 to be completely opened such that the sheet 40 can be unrolled or uncoiled from the wall member 20 (FIG. 2), and if included, the nozzle 26 (FIG. 2), it is not necessary to withdraw the nozzle 26 (FIG. 2) through the warming device 10, thereby reducing the risk that accumulated viscous fluid 14 (FIG. 2) on the cartridge 12 (FIG. 2) or nozzle 26 (FIG. 2) will make contact with the warming device 10 and adhere thereto.

It will be appreciated that different exothermic heat packs can output different amounts of thermal energy. Consequently, the particular type of exothermic heat pack employed can be selected to heat the viscous fluid 14 (FIG. 2) in the cartridge 12 (FIG. 2) to a desired temperature. Additionally or alternatively, the particular type of exothermic heat pack employed can be selected based on an ambient temperature of a work environment where the viscous fluid 14 (FIG. 2) is to be dispensed. In my testing, for example, I have noted that the Model 825B512 disposable hand warmer marketed by The Coleman Company, Inc. of Wichita, Kans. can be employed to heat the viscous fluid to a temperature of about 110° F. (from an ambient temperature of 70° F.); the “Foot Warm Up” and “HotHands-2” disposable warmers that are marketed by Heat Max, Inc. of Dalton, Ga. can be employed to heat the viscous fluid to a temperature of about 105° F. (from an ambient temperature of 70° F.); and the “Toe Warmer” disposable warmer that is marketed by Heat Factory of Vista, Calif. can be employed to heat the viscous fluid to a temperature of about 160° F. (from an ambient temperature of 70° F.). Accordingly, it is within the scope of the present disclosure to select a warmer from a plurality of warmers, in which each of the warmers is configured to output a different amount of thermal energy. The selection of the warmer can be at least partly based on a desired minimum temperature of the viscous fluid (i.e., to avoid situations where the viscosity of the viscous fluid is not too high or too low), a desired viscosity of the viscous fluid (which may be affected by the temperature of the viscous fluid), a cure time of the viscous fluid (which may be affected by the temperature of the viscous fluid), and/or an ambient temperature of an environment in which the viscous fluid is disposed or dispensed.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

What is claimed is:

1. An article comprising:
outer shell comprising a sheet that is at least partly formed of a material that reflects radiated heat, the outer shell having a first opening on a first side, the outer shell being adapted to receive therein a cartridge that holds a viscous liquid; and
a pocket coupled to an interior side of the outer shell, the pocket being woven from a thermally conductive material, the pouch being adapted to hold an exothermic heat pack, the thermally conductive material being woven with a mesh that is configured to permit air to flow though the woven thermally conductive material to sustain an exothermic reaction in the exothermic heat pack.

2. The article of claim 1, wherein the material that forms the outer shell includes a metallic reflecting agent.

3. The article of claim 2, wherein the metallic reflecting agent has a gold or silver color.

4. The article of claim 3, wherein the metallic reflecting agent is at least partly formed of aluminum.

5. The article of claim 1, wherein the thermally conductive material is selected from a group consisting of metals, carbon, plastics and combinations thereof.

6. The article of claim 1, wherein the thermally conductive material is a thermally conductive carbon cloth.

7. The article of claim 1, wherein the outer shell further comprises a closure means for securing the sheet in a rolled condition that is adapted to receive the cartridge therein.

8. The article of claim 7, wherein the closure means cooperates with the sheet to form a nozzle space that is adapted to receive a nozzle associated with the cartridge.

9. The article of claim 1, wherein the sheet defines a pair of mating closure tabs and wherein the closure tabs are secured together so as to define a nozzle space that is adapted to receive therethrough a nozzle associated with the cartridge.

10. A method for dispensing a viscous liquid, the method comprising:
providing a cartridge containing the viscous liquid;
inserting an exothermic heat pack in a pocket formed of a thermally conductive material;
abutting the pocket against the cartridge; and
wrapping a radiant heat reflecting material about the pocket and the cartridge.

11. The method of claim 10, wherein wrapping the radiant heat reflecting material about the pocket and the cartridge includes releasably securing the radiant heat reflecting material to itself.

12. The method of claim 11, further comprising:
dispensing the viscous liquid from the cartridge while the radiant heat reflecting material is wrapped about the pocket and the cartridge; and
unwrapping the radiant heat reflecting material from the cartridge after the viscous liquid has been dispensed from the cartridge.

13. The method of claim 10, further comprising activating the exothermic heat pack.

14. A combination comprising:
a warming device comprising a sheet, a closure means and a pocket, the sheet being formed of an insulating material that reflects radiated heat, the closure means being coupled to the sheet and including first and second portions that releasably engage one another to shape the sheet into a structure with a generally tubular shape, the pocket being coupled to the sheet on a side that positions the pocket within the generally tubular shape when the first and second portions of the closure means releasably engage one another, the pocket being formed of an air permeable thermally conductive material;
an exothermic heat pack received in the pocket; and
a cartridge containing a liquid, the cartridge being received in the generally tubular shape defined by the sheet and abutted against the pocket.

15. The combination of claim 14, wherein the material that forms the sheet includes a metallic reflecting agent.

16. The combination of claim 15, wherein the metallic reflecting agent has a gold or silver color.

17. The combination of claim 16, wherein the metallic reflecting agent is at least partly formed of aluminum.

18. The combination of claim 14, wherein the thermally conductive material is selected from a group consisting of metals, carbon, plastics and combinations thereof.

19. The combination of claim 18, wherein the air permeable thermally conductive material is a thermally conductive carbon cloth.

20. The combination of claim 1, wherein a nozzle is coupled tot he cartridge and wherein the sheet defines a pair of mating closure tabs and wherein the closure tabs are secured together so as to define a nozzle space through which the nozzle is received.
